(19) United States
(12) Patent Application Publication
(10) Pub. No.: US 2002/0154174 A1
(43) Pub. Date: Oct. 24, 2002

(54) Method and system for providing a service in a photorealistic, 3-D environment

(76) Inventors: Arthur Norman Redlich, Metuchen, NJ (US); John M. Goldsmith, New York, NY (US)

Correspondence Address: KENYON & KENYON, ONE BROADWAY, NEW YORK, NY, 10004, US

(21) Appl. No.: 09/840,595

(22) Filed: Apr. 23, 2001

(51) Int. Cl. G06F 3/00

(52) U.S. Cl. 345/848

(57) ABSTRACT

Method and system for providing 3-D services and 3-D visual directories in a photorealistic, 3-D virtual environment depicting a real-life entity. The real-life entity depicted in the 3-D virtual environment may be an actual place and/or actual entity that is not limited to a geographic location but may include other environments such as, for example, a subway system, library, a virtual card catalogue, a factory, an underground aqueduct system, an organism (e.g., an internal view of a human body), a cable system, a mechanism (e.g., a motor, a computer, a computer circuit), and a warehouse. A photorealistic, 3-D model is used as a platform for the services provided. These services may include mapping services, browsing services, historical services, educational services, entertainment services, and commercial services, such as advertising.

### FIELD OF THE INVENTION

The present invention relates to a method and system for providing a service in a photorealistic 3-D environment.

### BACKGROUND INFORMATION

The development of 3-D graphics and virtual reality modeling has led to dramatic improvements in computer-generated environments. From Ivan Sutherland's pioneering adaptation in 1966 of the Remote Reality vision systems of the Bell Helicopter project, virtual environments have evolved from a single wireframe room to the elaborate virtual environments being developed today. These virtual environments may encompass the gamut from a 3-D virtual reality (“VR”) world where a user's physical movements in the real world are translated into actions in the VR world to 3-D virtual environments digitally presented to a user where more traditional computer navigational and interaction commands are used to generate action in the virtual environment. Regardless of the degree of user immersion, visual environments generally may provide for greater data presentation and absorption as is highlighted in a common expression “a picture is worth a thousand words.” Despite these advantages, comprehensive services available in these 3-D virtual environments, including visual browsers for a real-life entity (hereinafter used to refer to an actual place and/or actual entity), do not currently exist.

The concept of virtual environments is conventionally known and has been addressed by both engineers and writers. Neil Stephenson, a leading writer in this genre, describes in his novel Snow Crash a further evolution of the World Wide Web (“Web”) termed the Metaverse. In Stephenson's book, the Metaverse is a virtual environment where users may interact personally and/or commercially with other users. Users are represented in the Metaverse by individual avatars, which are human-like representations of them. Though Snow Crash discusses virtual real estate, the Metaverse is not a representation of a real-life entity (i.e., an actual place and/or actual entity). Stephenson's Metaverse does not describe the photorealistic, 3-D services for real-life entities that are lacking today.

Along similar lines as the Metaverse, companies such as www.activeworlds.com and www.blaxxun.com offer virtual worlds where users may visit virtual locations such as virtual malls. These multi-user virtual worlds, like the Metaverse, are not representations of real-life entities (i.e., actual places and/or actual entities). Additionally, the locations of entities and places within these virtual worlds do not correspond to an actual physical context (i.e., positioning in relationship with other entities and places) in which the entity or place is located. For example, these virtual malls do not represent actual malls nor are they located in an environment modeled after an actual city or town-both important aspects in representing a real-life entity. Additionally, these virtual worlds are generally not photorealistic presentations and may appear cartoon-like in their visual display. Like the Metaverse, these virtual worlds do not provide sophisticated photorealistic 3-D services for real-life entities.

In an urban planning context, 3-D models of actual locations are known and are relatively common. However, these urban planning 3-D models are not designed in a manner to provide mapping service to a user, visual browsing service, educational, or entertainment services nor do they provide for commercial advertising and immersive e-commerce. Additionally, urban planning 3-D models are often not photorealistic in presentation. For these reasons, urban planning 3-D models do not satisfy the need for sophisticated photorealistic, 3-D services for actual places and/or actual locations.

Even though photorealistic, 3-D services for actual places and/or actual entities do not currently exist, numerous less sophisticated services do. MapQuest® and other 2-D mapping services provide neither photorealistic displays nor 3-D models and therefore do not allow a user to experience a representation of an actual place. Additionally, 2-D mapping services do not incorporate embedded advertising or immersive e-commerce in their 2-D displays. Other terrain and aerial mapping services are also limited. These aerial mapping services, such as www.getmapping.com and www.geosoftware.com, do not provide street level views nor do they allow users to plan and witness virtual trips. Navigation between locations in the mapped environment does not occur other than by scrolling through the maps. These existing mapping services do not provide photorealistic 3-D models of actual places and do not provide enhanced mapping services such as virtual trips.

Existing 3-D services for actual entities are similarly limited. Actual entities may consist of organisms such as a human body or animal or part of the same. Conventional services for these organisms include the actual scanning and viewing of the organism using medical and/or research devices. These systems are limited in their ability to record, present, and allow manipulation of the environment. For example, conventional system do not allow the virtual navigation of a human coronary system, pulmonary system, or nervous system. In fact, these system provided limited views and do not provide enhanced services such as embedded and immersive e-commerce and educational services to teach in a 3-D, photorealistic environment.

Additionally, what many people consider 3-D virtual environments are really linked panoramas (e.g., linked 2-D panoramas) that simulate a 3-D virtual environment. In these panoramas, users can not freely move throughout the environment due to the two-dimensional nature of the environment even though the images may appear 3-D. For example, images created using iPIX® and QuickTime VR® are examples of these types of panoramas. In reality, what often appears as a 3-D environment is a 2-D image or panorama with 3-D appearance.

Web-based and stand-alone 3-D games may provide photorealistic, 3-D environments, however, these photorealistic, 3-D environments do not represent actual places and/or actual entities nor do they provide sophisticated services. In fact, conventionally known games typical provide a limited, scripted interaction with the environment. Additionally, 3-D games do not contain embedded advertising and immersive e-commerce.

Conventional 3-D environments and their associated services do not fill a current need for photorealistic, 3-D virtual environments representing actual places and/or actual entities and associated sophisticated services. In particular, current photorealistic, 3-D environments do not provide mapping, visual browsing, historical, educational, entertainment, and commercial services for actual places and/or actual entities. Environments containing and or reflecting actual places and/or actual entities depict what a user may really see and/or experience and allow greater mapping, visual browsing, historical, educational, entertainment, and commercial opportunities than are currently available. The present invention fills this need by providing a photorealistic 3-D environment representing actual places and/or actual entities with a set of services to allow a user to fully exploit the environment for a particular purpose. The present invention also allows for embedded advertising in the 3-D environment as well as interactive and immersive e-commerce.

### SUMMARY

The present invention solves for these needs through a method and system for providing services in a 3-D, photorealistic environment depicting an actual place and/or an actual entity. The present invention uses a photorealistic model of an actual place and/or an actual entity so that sufficient similarity between the virtual environment of the model and the actual environment exists to provide a user with cognitive recognition of the environment. The actual place and/or actual entity depicted in the 3-D, photorealistic model may include all or part of a geographic area such as a city/town, province/county, or country. The actual place and/or the actual entity may also depict a non-geographic area such as a subway system, a library, a virtual card catalogue, a factory, an underground aqueduct, an organism (e.g., an internal view of a human body), a cable system, a mechanism (e.g., a motor, a computer, a computer circuit, a boat), and a warehouse. The services provided for the 3-D, photorealistic environment (i.e., the model) may include, inter alia, mapping services, browsing services, historical services, educational services, entertainment services, and commercial services.

The photorealistic, 3-D modeling of the actual place and/or the actual entity does not need to be a 100% accurate representation. Liberties may be taken with the accuracy of the 3-D modeling for a variety of reasons. For example, some changes in an actual place and/or actual entity may be so temporary in nature that incorporating them into the model will create greater problems and potentially lead to greater inaccuracy in the modeling. Two examples of a temporary change may include a road accident and a minor road repair project. Two other examples of a temporary change may include a clot in an artery of the cardiovascular system of a human being and a temporary swelling or inflammation along the pulmonary system of a human being. Another reason for spurring accuracy to some degree may be the need to include advertisements and/or other e-commerce options (e.g., a hawker on the street selling wares) in the 3-D virtual environment. Even questions of resolution and the bandwidth consumed and loading time necessary may make a simplification of some models or parts of models necessary. Despite these reasons for not having a 100% accurate reproduction, the closer the 3-D model environment represents the actual location and/or actual entity being depicted, the greater the utility the present invention may hold for a user.

The photorealistic, 3-D virtual environment should be of a sufficient scope to provide the user a sense of context. For example, a 3-D model of a single building has no context in which it belongs and therefore is not particularly useful with mapping services or visual directories. Similarly, an isolated street has no context without its surrounding buildings and streets. An internal representation of a building, store, or mall may also provide insufficient context if enough of the interior normally accessible to a consumer is not included in the model. Whether the model relates to an interior environment, an exterior environment, or an entity such as an animal or a mechanism, the scope of the 3-D model should preferably be sufficient to provide a user with a sense of place or context within which the model belongs.

The present invention may be implemented, according to the exemplary embodiment, using a client-server architecture connected over an information network such as the Internet. The server-side of the architecture stores the 3-D environment data and associated multimedia files, texture maps, and other data. The server sends the content to the user when the user visits the Web site of the present invention operator and requests the 3-D virtual environment. The client-side of the architecture uses a Web browser to communicate with server over the Internet. The client may also host the 3-D graphical user interface (“GUI”) necessary to receive the 3-D data, interpret it, and display the 3-D environment. The 3-D GUI may be a Web browser plugin, ActiveX control, or standalone application that is capable of handling information in the format stored by the server. The 3-D GUI may be stored on the client-side or may be stored with the server and downloaded to the client when necessary. Additionally, an application GUI is necessary to allow the user to interact with the 3-D environment. The application GUI may be part of or separate from the 3-D GUI used for invoking the 3-D environment. The application GUI may have customized controls (e.g., navigation controls) that facilitate interaction within the 3-D environment. These customized controls may also allow a user to access a feature of a service offered for the photorealistic, 3-D environment. The client may store the application GUI or it may be stored by the server and downloaded to the client when necessary. The application GUI and 3-D GUI may both comprise a single software application (e.g., Web browser plugin, ActiveX control, C++program, and java applet) or may be separate software applications. Both the 3-D GUI and the application GUI may be necessary for the present invention to work properly.

The application GUI may provide the navigation controls for the 3-D virtual environment. According to one embodiment of the present invention providing mapping services in the photorealistic, 3-D, virtual environment, the application GUI may allow the user to toggle between a street level and aerial view of the 3-D environment. It may also provide trip-planning tools. For example, a user may navigate from one location in the 3-D environment to another by specifying a start and destination address with a “jump to” or “travel to” command in the application GUI. Start and destination addresses may be street addresses or landmarks that a user may directly enter into the application GUI or the user may chose these start and destination addresses from one or more pull-down menus. In this example, the user may also control the speed of the virtual trip and make stops along the way if desired. In another example, the application GUI may allow the user to toggle between a cross-sectional view and an internal view of a human body or part of a human body. In this example, the application GUI may allow the user to navigate within the 3-D environment of the human body. If this example is applied to a human cardiovascular system, an internal view of an artery would appear as being inside the artery and navigation controls may allow movement within the artery and along the cardiovascular system. A cross-sectional view, in this example, would appear as cross-section of the artery and the navigation controls may allow shifting of the cross-section to move the cross-sectional view. In this human body example, trip and “jump to” features may also be available allowing preprogrammed movement within the human body.

The application GUI may also allow the user to zoom-in or zoom-out on a particular reference point in the 3-D environment. According to one embodiment of the present invention providing mapping services for a geographic location, a user may zoom-in using the aerial mode until the view is so close that the visual perspective (i.e., the orientation of the photorealistic, 3-D environment as displayed to a use-the “orientation” for short) is switched from an aerial mode to a street level mode. The user may also zoom-out until a planet, such as the earth is in view. The planetary top-level view may be used as an initial default view from which a user navigates to their desired area either by using the zoom-in feature or the find feature of the application GUI according to one embodiment of the present invention. In another embodiment of the present invention providing mapping services for an entity such as an organism including the human body, zooming-in and zooming-out may, at a certain point, switch the visual perspective (i.e., the orientation) between the internal view and the cross-sectional view.

The application GUI may also be used for the execution of other services and features. For example, when mapping services are used, a user may use the application GUI to mark a path between the start and destination points (which may be addresses) and/or the user may decide to identify some or all of the landmarks in the 3-D environment. Path marking may be a simple option whereby a route is marked using smoke, colored fog, or other 2-D or 3-D effect. The application may also allow a user to select which landmarks to identify and then to place an identifier, such as a flag, on each selected landmark. For example, if a user decides to identify all the restaurants in the 3-D environment and makes the appropriate selection(s) through the application GUI, all the restaurants in the 3-D virtual environment visible to the user may have a flag identifying the facility as a restaurant on top of them. The user may select which landmarks will be identified through a pull-down menu of a pop-up window available in the application GUI.

The present invention may generate revenue by charging for advertising within the 3-D environment and for the rental or sale of real estate within the 3-D environment. Advertising may be placed where actual advertising exists in the real world, such as the electronic billboards in Times Square. Advertising may also be added to the 3-D model even where it does not exist in the actual location being modeled. The revenue generation model may also include the charging of fees for interaction between an enterprise and a user. For example, a store may be charged for the provision of a interior display store display in the 3-D environment, the direct sale of merchandise through user interaction with the 3-D environment, or other interaction with a user in the 3-D virtual environment.

### BRIEF DESCRIPTION OF THE DRAWINGS

FIG. 1 is a block diagram depicting an example of a network topology illustrating the relationship between the Internet, users, a virtual environment Web server network node, and a content provider Web server network node according to one embodiment of the present invention.

FIG. 2 is an illustration of an application graphical user interface (“GUI”) in street level navigation mode according to one embodiment of the present invention.

FIG. 3 is an illustration of three different viewpoints of the same 3-D environment displayed from a street level perspective as a user navigates down a road according to an embodiment of the present invention.

FIG. 4 is an illustration of an application graphical user interface (“GUI”) in aerial navigation mode according to one embodiment of the present invention.

FIG. 5 is an illustration of three different viewpoints of the same 3-D environment displayed from an aerial perspective as a user navigates and changes elevation within a small town according to an embodiment of the present invention.

FIG. 6 is an illustration of a 3-D virtual environment that has been zoomed out to the extreme where the planet Earth is being displayed according to one embodiment of the present invention.

FIG. 7 is an illustration of the start address and destination address pop-up windows according to one embodiment of the present invention.

FIG. 8 is an illustration of the navigation options pop-up window according to one embodiment of the present invention.

FIG. 9 is an illustration of the landmark selection pop-up window according to one embodiment of the present invention.

FIG. 10 is an illustration of the application GUI displaying a street level view of the 3-D virtual environment where all the landmark categories have been selected and are being shown according to one embodiment of the present invention.

FIG. 11 is an illustration of the application GUI displaying an aerial view of the 3-D virtual environment where all the landmark categories have been selected and are being shown according to one embodiment of the present invention.

FIG. 12 is an illustration of the application GUI displaying a street level of the 3-D virtual environment where only restaurant landmarks have been selected and are being shown according to one embodiment of the present invention.

FIG. 13 is an illustration of the application GUI displaying an aerial view of the 3-D virtual environment where only restaurant landmarks have been selected and are being shown according to one embodiment of the present invention.

FIG. 14 is an illustration of an advertiser's Web page displayed in the information window of the application GUI as a result of a user clicking on a hyperlink associated with the advertiser's store located in the 3-D virtual environment according to one embodiment of the present invention.

### DETAILED DESCRIPTION

The present invention is a method and system for providing 3-D services and 3-D visual directories in a photorealistic, 3-D virtual environment depicting an actual place and/or an actual entity. The actual place and/or the actual entity depicted is not limited to a geographic location but may include, inter alia, a subway system, a library, a virtual card catalogue, a factory, an underground aqueduct, an organism (e.g., an internal view of a human body), a cable system, a mechanism (e.g., a motor, a computer, a computer circuit, a boat), and a warehouse. 3-D services may include, inter alia, mapping services, browsing services, historical services, educational services, entertainment services, and commercial services.

The mapping services that may be provided are varied and may include, inter alia, trip planning, virtual trips, best route determination, route viewing, finding locations/destinations, and general navigation. According to one embodiment of the present invention, these mapping services may be provided from different perspectives (i.e., the orientation of the photorealistic, 3-D environment as displayed to a use-the “orientation” for short) such as from a street level view and/or from an aerial view. Additionally, the mapping of the 3-D virtual environment depiction of an actual location may vary in scope from the interior of, for example, a building, mechanism, organism, or mall to an entire city, state, province, or larger entity.

Browsing services may be provided that allow a user to visually browse through any place such as, for example, browsing through a city/town, a mall, a store, a subway system, a bus line, an airport, a library, a virtual card catalogue, a factory, a school, the respiratory tract of a human body, a telephone system, the arterial system of a cat, and the bus system of a computer motherboard.

Historical services may provide re-creations of any place (as specified above) at any prior period of time for which information exists, can be inferred, or may be estimated. An example of a historical service may include a 3-D virtual environment of a western town based on photographs of the town. Another example of a historical service is a view of a city or town such as San Francisco, Calif. in 1990 or Sierra Vista, Ariz. in 1987. Historical views may provide a fourth dimensional ability to view a place.

Educational services may include educational applications of the 3-D environment such as a 3-D atlas and/or 3-D encyclopedia. Educational services may be related to other services such as, for example, historical services. For example, a re-creation of the ancient Greek city-state of Sparta may be a historical service and an educational service.

Entertainment services may include novel constructions of the virtual 3-D representations of actual places to entertain users. For example, an entertainment service may include a virtual NFL® world containing 3-D virtual representations of actual NFL® stadiums but not in their actual context (e.g., all located next to each other in the virtual world unlike being located in their respective cities-their actual context-in the real world). In another example, a museum virtual world containing 3-D representations of actual museums but not in their actual context may be an entertainment service.

Commercial services may include any commercial uses of the 3-D environment. For example, the sale or use of advertising within the 3-D virtual world may be a commercial service. In another example, a commercial service may include the sale of merchandise online initiated through interaction within the virtual world. In this example, the interaction may occur within a store (e.g., the Gap™) located in the virtual world. In a third example, the sale of real property or virtual property may occur through interaction with the virtual world.

A virtual directory is another service that may be provided by the present invention. According to one embodiment of the present invention, the 3-D photorealistic virtual environment may represent any type of virtual directory. For example, the virtual environment may include a 3-D virtual directory of a mall. The user may click on a store in the directory and directions or other information may appear, such as, for example, a marked route from the user to the desired store. Another example of a virtual directory may include a virtual card catalogue. Virtual card catalogues may be used to find, for example, books in a library or recipes in cookbook. Any existing electronic or graphic directory may be converted into a virtual directory.

The above-mentioned definitions of services is not exclusive and may overlap.

System Architecture

The present invention, according to various embodiments, may be implemented using a variety of system architectures. In all embodiments, the system architecture for the present invention includes both hardware and software as described below. The system architecture may be implemented using client-server architecture with client and server hardware devices and associated software. The system architecture may also be implemented using a standalone client device incorporating both client and server functions as described below.

A client device may be one or more devices for receiving user input and providing for the processing and display of the content to the user. The client device may be a single integrated device providing all these features such as a personal digital assistant (“PDA”), mobile phone, or laptop computer. The client device may also consist of separate component devices for the input, display, and processing of data such as a personal computer system. A client input device may include but is not limited to a keyboard, mouse, trackball, joystick, stylus, touch screen, microphone, and video camera. These devices may allow the user to interact with the present invention. For example, the video camera may be used to generate an avatar to represent the user in the 3-D virtual environment or it may be used for video conferencing. A client display device may include but is not limited to a monitor (e.g., a CRT screen or LCD), a television set, a projection device (e.g., a digital image projector or film projector), heads up display (e.g., an automobile or aircraft heads up display), and virtual reality goggles. A client-processing device may be any device with a processor capable of rendering 3-D graphics for display to a user. For example, a computer, PDA, mobile phone, intelligent TV, and a processor embedded in an automobile may all serve as a client processing device. A single device or any combination of input, display, and processing devices may serve as the overall client device used by the present invention.

A variety of different client devices may be used for the present invention. In one embodiment, a computer system may serve as the client device. In another embodiment, an automated kiosk located, for example, in a mall or an airport, may be used as a client device. In this embodiment, a touch screen may be used as one possible client input device for the kiosk. Another example of an automated kiosk may be an ATM which may incorporate a photorealistic, 3-D model according to the present invention. Other embodiments of the present invention may use other client devices including, inter alia, mobile phones and personal digital assistants as previously discussed.

A server is one or more devices that may be used by the present invention for the storage and delivery of 3-D environment content to the client devices. Typically, a server will be one or more computer systems but may include a variety of processing and storage devices. The server communicates with a client device over an information network therefore requiring both servers and clients to have appropriate network connection devices such as, for example, modems. The information network over which the server communicates with the client may be any information network such as the Internet, public switched telephone network (“PSTN”), local area network (“LAN”), wide area network (“WAN”), metropolitan area network (“MAN”), and wireless network.

In one embodiment, the present invention may function as a stand-alone system that does not require a connection over an information network. According to this embodiment, the 3-D virtual environment content may be provided to a user via a client device using some storage means. The 3-D environment content otherwise provided on a server may instead be distributed to the client device and stored with it using any feasible storage device such as one or more CDs, DVDs, PCMCIA cards, flash memory devices, memory chips, Zip™ disks, Jazz™ disks, floppy disks, hard drives, optical disks, DAT tapes, and other tapes.

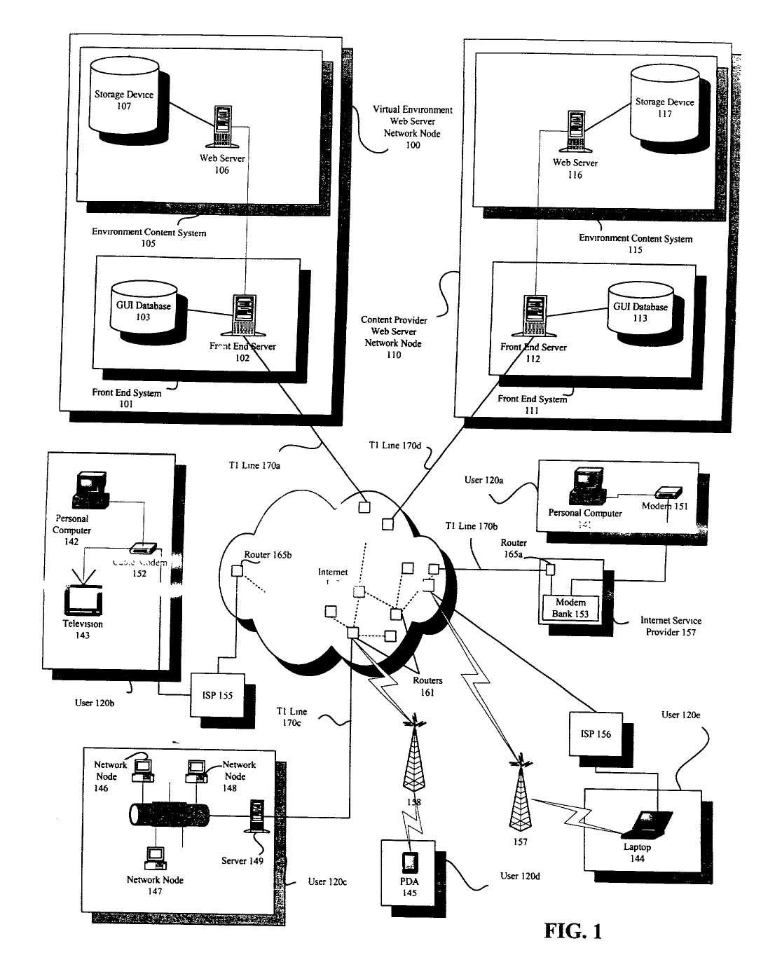

The exemplary embodiment of the present invention uses a client-server architecture where the client device and server are connected over the Internet. FIG. 1 is a block diagram depicting an example of a network topology illustrating the relationship between the Internet, users, a virtual environment Web server network node, and a content provider Web server network node according to one embodiment of the present invention. The virtual environment Web server network node 100 and content provider Web server network node 110 may make available one or more Web sites that users 120 may visit by connecting to the respective network node. The Web site provided the virtual environment Web server network node 100 may allow a user to access a 3-D virtual environment while some of the information necessary for the 3-D environment or the user interaction within the environment may be provided by the content provider Web server network node 110. A Web site is a grouping of one or more associated Web pages sharing a common domain. Each Web page is a document defined using a markup language such as the HyperText Markup Language (“HTML”), the eXtensible Markup Language (“XML”), or any other suitable language. The Web page document contains markup language instructions and references to objects (used herein to describe the text, images, hyperlinks, banner advertisements, buttons, etc. that are displayed on the Web page) that are interpreted by a Web browser to provide a display of information to a user. These markup language instructions may include directions for finding and displaying specific objects within the document such as a plugin or ActiveX control to display 3-D virtual environment data. These specific objects may be located at other Web sites or on other Web servers. Objects may include any number of distinct elements in the document. For example, objects may include e-mail messages, text, icons, images, animation, charts, spreadsheets, 3-D virtual environment information, etc. Components may be objects in their own right or may be portions of an object such as figure or element of a drawing or a logo. When a user 120 views a document such as a Web page, the markup language document may be transmitted to the user 120 over an information network such as the Internet 160 if a locally stored version of the Web page is not available. A user's local Web browser application (not shown) may receive the document and interpret the markup language code resulting in a Web page being locally displayed.

Users 120a-120e are coupled to the virtual environment Web server network node 100 and the content provider Web server network node 110 via an information network such as the Internet 160. According to the embodiment depicted in FIG. 1, virtual environment Web server network node 100 is coupled to the Internet 160 via T1 line 170a while content provider Web server network node 110 is coupled to the Internet via T1 line 170d. In particular, each user 120 is coupled to the Internet 160 via a respective network interface. Users 120a, 120d-e may utilize a narrowband network interface while users 120b-c, 120e may utilize a broadband network interface.

User 120a illustrates an example of a typical narrowband client connected to the Internet 160 via a dial-up connection. User 120a uses a personal computer 141 and a modem 151 to access Internet Service Provider (“ISP”) 157 and navigate the Web 160 via Web browser software (not shown). The Web browser software permits navigation between various Web document servers connected to the Internet 160, that may include the front-end server 102 at virtual environment Web server network node 100 and the front end server 112 at content provider Web server network node 110. In addition to assisting with navigation between Web servers, the Web browser software interprets the markup language codes contained within Web documents (i.e., Web pages) and provides functionality for the rendering of files distributed over the Internet (e.g., through the use of plugins or ActiveX controls).

User 120b illustrates an example of a typical broadband client connected to the Internet 160 via a cable connection. User 120b uses a personal computer 142 and a cable modem 152 to access ISP 155 via the cable connection and navigate the Web 160 via Web browser software (not shown). User 120c illustrates an example of a typical broadband corporate client with internal network nodes 146-148 which are coupled to the Web and Internet 160 via a local Ethernet network 150, server 149, and T1 line 170c of the corporate client. Internal Ethernet network nodes 146-148 may also use Web browser software (not shown) to navigate the Web 160. User 120d illustrates an example of a narrowband client using a personal digital assistant (“PDA”) 145 to connect to the Internet 160 via a wireless connection 158. User 120e illustrates an example of a narrowband or broadband client using a laptop 144 to connect to the Internet 160 by either a wireless connection 157 or land line connection to an ISP 156. Users 120d-120e may also use Web browser software (not shown) to navigate the Web 160. Although FIG. 1 illustrates five example users 120a-120e, it is to be understood that virtual environment Web server network node 100 and content provider Web server network node 110 may serve any arbitrary number of users 120 limited only by the processing power and bandwidth available.

The specific nature of users 120a-120e and the methods through which they are coupled to the Internet 160 depicted in FIG. 1 are merely exemplary. The present invention is compatible with any type of Internet client and/or connection (broadband or narrowband). In general, it is to be understood that users 120 may connect to the Internet 160 using any potential medium whether it be a dedicated connection such as a cable modem, T1 line, DSL (“Digital Subscriber Line”), a dial-up POTS connection or even a wireless connection.

Software

In addition to the Web browser software discussed, the exemplary embodiment of the present invention may require additional 3-D graphical user interface (“GUI”) software in order for the user to be able to view and interact with the 3-D environment. The 3-D GUI software may be a stand-alone application, java applet, browser plugin, or ActiveX control. The 3-D GUI software should support the data format used by the server for the presentation of the 3-D environment data. For example, supported 3-D display formats may include VRML, Metastream®, or X3D. Other software may also be necessary to display specific multi-media files such as video and sound files that may be displayed as part of the 3-D environment or otherwise included in the present invention. This other software and 3-D GUI need to be available to the client devices for the users 120a-120e.

On the server side, the 3-D content files, including texture maps and multi-media files, need to be stored and available for downloading to the users' 120a-120e client devices. The 3-D content files may be stored at the virtual environment Web server network node 100, the node of the present invention provider. Additional contents files may be retrieved by the virtual environment Web server network node 100 from a content provider Web server network node 110 according to one embodiment of the present invention. For example, a store owner may store, at the content provider Web server network node 110, the display of an interior of a store, the items available in the store, the organization of the items, and the user interaction within the store. According to this example, when a user navigating through a 3-D environment enters the store, the additional information concerning the store interior may be retrieved from the content provider Web server network node 110 either directly by the client device or by the virtual environment Web server network node 100 which will then forward the data to the client device.

An application GUI may also be necessary to allow the user to interact with the virtual environment Web server network node 100 and/or the 3-D virtual environment. The application GUI may contain custom navigation controls for the 3-D environment. The application GUI and 3-D GUI may be separate software or both parts of the same software application. Both the application GUI and the 3-D GUI may be located on the client device or may located on the server, such as the virtual environment Web server network node 100, and downloaded by the server to a user's 120a-120e client device.

In an exemplary embodiment, the present invention uses 3-D models in VRML format. In this embodiment, the Worldview®, the Blaxxun®, or other interactive VRML plugin for Microsoft's Internet Explorer Web browser along with present invention-specific javascript VRML extensions are used for providing the 3-D GUI. Additionally, java applets are used to generate the application GUI for the services. The java applets communicate with the extended (i.e., present invention-specific extension of the) VRML plugin through the Extended Authoring Interface (EAI), an application programming interface that allows Java applications to communicate with a VRML browser. In this exemplary embodiment, the 3-D environment is accessed by a user through a Web page containing links to (i.e., a Web page with an embedded) VRML plugin, javascript, and java applets.

Modeling of Actual Places

In one embodiment of the present invention, the 3-D virtual environment models an actual location. For example, an actual city, town, or section thereof may be modeled and an associated 3-D virtual environment created. In another example, the 3-D virtual environment model may include the inside of a mall, store, or building. A 3-D model of a mall may include all the tenant stores and other features of the mall including kiosks, food court areas, and directory maps. As with other stores, the stores in the mall may also be visited if their interior has been included in the model. For example, a user may visit a toy store in a mall and browse through the items that are available for sale.

Though a 3-D model according to the present invention should represent an actual location, the model does not need to be 100% accurate. For example, a 3-D model of a town may not reflect a traffic accident or road work. Also, a 3-D model of a store does not need to have all the shelf space or goods organized exactly like the real store nor does it need to carry exactly the same items. Even though exact replication of the actual location in the 3-D modeled virtual environment is not necessary, the greater the similarity of the virtual environment to the actual environment, the greater the potential benefit to the user.

Modeling of Actual Entities

In addition to actual places, the 3-D virtual environment may depict an entity such as a mechanism or an organism according to one embodiment of the present invention. For example, a mechanism may be the internal workings of a device such as an automobile engine. In another example, an organism may be a human or an animal. In this case, the 3-D virtual environment may be an entire human or animal body or a part thereof. For example, an actual entity may be the cardiovascular, pulmonary, or nervous system of a human body. Actual entities may include many non-geographic models that may be incorporated into a 3-D, photorealistic environment.

Movement and Change (Realism) in the Modeling

One aspect of the present invention may include the use of animation and other techniques to simulate movement and change in the photorealistic, 3-D model. For example, changes in the amount of daylight reflecting the time of day and time of year may also be incorporated into the model. Another example, weather effects may also be incorporated into the model so that a cityscape may reflect weather such as rain, snow, cloudiness, etc. A third example of realism is the modeling may include the use and movement of animals. For example, birds flying in the sky, cows grazing in a field, and/or dogs and cats moving around a city may all be included in the model. Along similar lines, people, traffic, airplanes, and other types of movement and change may also be included. One further example may include building lights, signs, and/or streetlights going on and/or off. Other types of movement may also include animated billboards (as discussed below).

In another embodiment of the present invention, a user of the present invention may have the ability to move objects such as buildings and signs around within the 3-D model. Additionally, users may be allowed to add and/or import new objects such as buildings into a 3-D model. These additional features for movement, addition, and importation may be used to explore (from all or a wide variety of angles) the potential impact of changes to an actual location and/or entity prior to making the changes in the real world. For example, developers and town planners may see what a new or refurbished building may look like in its appropriate context (i.e., in situ). In another example, a building and/or store owner may see what potential changes will look like, such as the addition of a sign or changes to an interior, prior to making them.

Scope of the Virtual Environment

The scope of the actual location modeled should contain enough of a contiguous region to provide the user a sense of context according to one embodiment of the present invention. For this reason, in the exemplary embodiment, the 3-D virtual environment should extend beyond an isolated street or building and be sufficient to give the user a sense of place. In particular, for a mapping service and for planning virtual trips, enough of a geographic area should be included in the 3-D environment to make a mapping service and/or virtual trip service useful. In another embodiment of the present invention, virtual environments for an interior of a building or enclosed mall may provide sufficient context if all or most of the interior or the area of the interior accessible to a consumer is included. In the context of a mall, this coverage does not necessarily mean that the interiors of the individual stores need be included in the 3-D environment for this other embodiment. In another example, if the 3-D environment is the pulmonary system of a human body, contiguous anatomical regions may be incorporated to provide the context for the pulmonary system.

Photorealistic 3-D Models

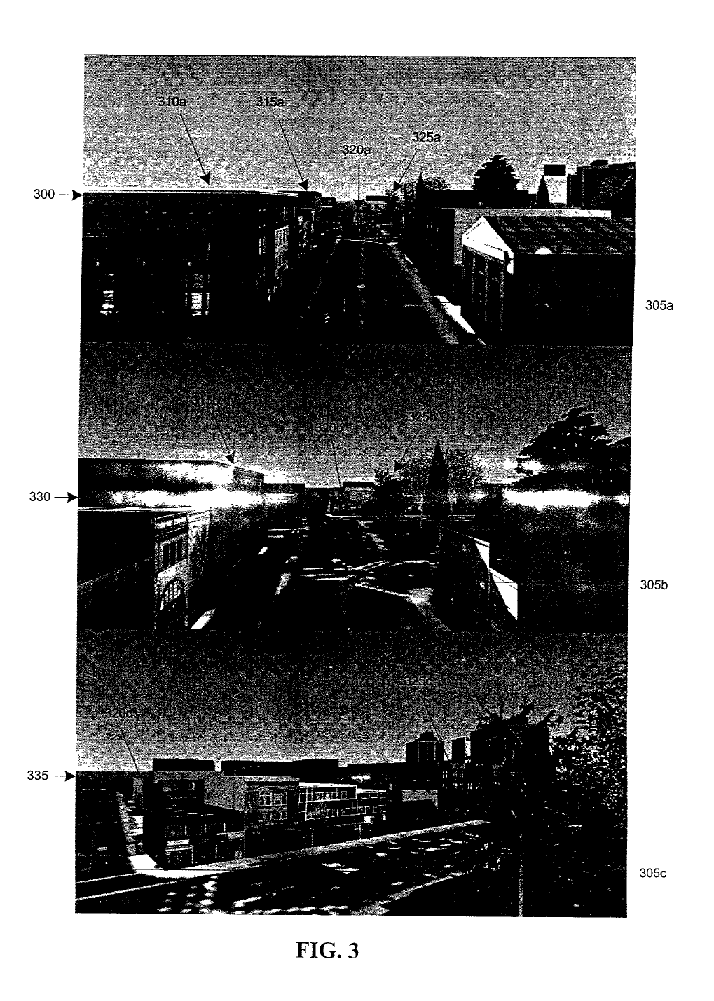

The present invention may use a photorealistic 3-D model of an actual location so that the visual presentation may provide a similar and recognizable representation of the actual location depicted. This similarity between the 3-D model and the actual location may allow a user to see a virtual representation of what an actual trip may look like. For example, a user may plan a driving excursion through a city or town and may virtually experience the trip prior to actually taking it. In this manner, a user may familiarize himself/herself with an environment prior to or instead of actually, physically entering the environment. FIG. 3 is an illustration of three different viewpoints along a drive down a street in a 3-D photorealistic model of a town. By viewing the trip in the 3-D virtual environment, a user may identify landmarks, destinations, routes, rest stops, etc. to assist in planning an actual trip or in retracing a previously taken trip. Additionally, a 3-D photorealistic environment may be used to provide a user a virtual trip in place of an actual trip.

A photorealistic 3-D model of an actual location may also assist a user in visually browsing a particular location. For example, a user may browse through a town, a mall, a university, etc. quickly. A user may also, according to one embodiment of the present invention, browse inside a store and examine products that may actually be for sale in the real world store depicted. In this manner, a user may take a trip to a distant mall, examine goods for sale in the various stores, and possibly execute a transaction without having to actually make a physical trip.

Application GUI/User Interface

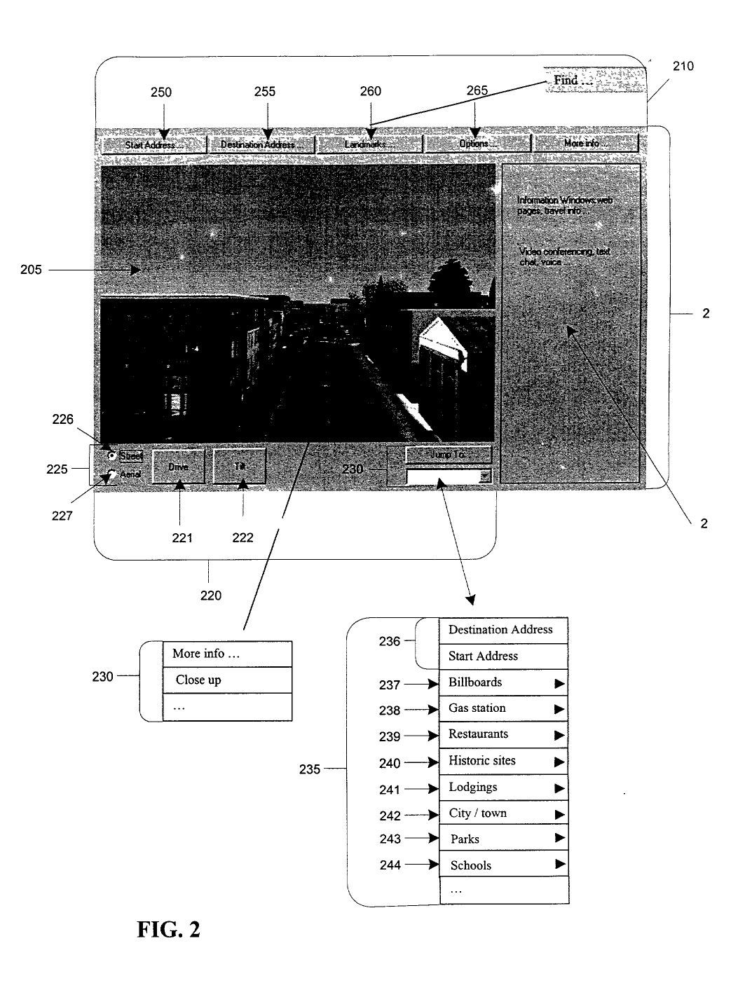

The application GUI or user interface may provide custom navigational controls that allow the user to interact with the 3-D virtual environment. For example, the application GUI may allow the user to plan a trip, drive, or fly in the 3-D environment. FIG. 2 is an illustration of an application graphical user interface (“GUI”) in street level navigation mode according to one embodiment of the present invention. The application GUI window 200 includes a 3-D virtual environment display 205, a tool bar 210, an information window 215, and navigation commands 220. The 3-D virtual environment display 205 provides the graphical presentation of the environment to the user. By clicking directly on the display 205, a user may be able to zoom in or out, obtain additional information, or navigate within the environment. For example, if a user clicks on a building or a door to a building, the user may move inside the building. Similarly, if the user clicks down a road, the user may move to that destination in the road. A user may also right mouse click on a building, person, or other object/entity in the environment to call up an interaction menu 230 to allow additional interaction options. For example, a user may right click on a store clerk to initiate a buy transaction or to obtain information. A user may also right click on a building, sign, or any other object/entity to obtain additional information about that object/entity. This additional information may be provided by audio to the user or may be provided by text in the information window 215. The contents of the pop-up interaction menu 230 may be tailored to the type of object/entity clicked on (e.g., building, road, and person) and/or to particular preferences of the user.

The display 205 may be shown from one or more perspectives (i.e., orientations) such as a street level perspective and an aerial perspective. The user may toggle the display 205 between these perspectives using a perspective radio field 225. In the embodiment shown in FIG. 2, the perspective radio field 225 contains two options street 226, for a street level view, and aerial 227, for an aerial view. The chosen and displayed perspective in FIG. 2 is a street level perspective. The perspective may determine the navigation commands 220 available to the user. The exemplary embodiment uses a drive 221 and tilt 222 navigation commands 220. Drive 221 may allow a user to move in any direction along the ground. The drive command 221 may also allow the user to control the speed at which the driving in the 3-D virtual environment occurs. The tilt command 222 may allow the user to look up and down in the 3-D virtual environment.

A “jump to” or “travel to” command 230 may allow the user to take an automated virtual trip along the best route to a particular destination. The jump to command 230 shown in the embodiment depicted in FIG. 2, allows the user to enter the destination or choose a destination from a pull-down menu or series of pull-down menus 235. The pull-down menus 235 may contain any number of possible destinations including the start address or destination address for the virtual trip 236, billboards 237, gas stations 238, restaurants 239, historic sites 240, lodgings 241, cities and towns 242, parks 243, schools 244, and other possible locations along the trip route. The billboards pull-down menu item 237, the gas stations menu item 238, the restaurants menu item 239, the historic sites menu item 240, the lodgings menu item 242, etc. may provide an additional pull-down menu allowing a user to select from recently passed locations. Alternatively, these additional pull-down menus may list upcoming locations or all locations passed and upcoming. For example, the “billboards” pull-down menu 237 may contain a listing of billboards the user has recently passed thus illustrating a pull-down menu listing of passed locations. The gas stations pull-down menu option 238 may contain a listing of the upcoming gas stations on a virtual trip ordered by the distance from the gas station to the user and thus illustrating a pull-down menu listing upcoming locations. The restaurants pull-down menu option 239 may contain a listing of all restaurants along a virtual trip route illustrating a pull-down menu listing both passed and upcoming locations.

With the jump to command 230, users may stop at locations along the way or may jump ahead or back along the trip route. Users may want to stop along the way during a trip in order to view information about various locations, interact with entities in the 3-D environment such as store clerks, and to window shop. A user may also deviate from the route selected by the present invention by using the navigation controls to alter the course as driving is occurring (i.e., the drive command has been selected). The user may at any time decide to use the navigation controls to explore other geographic areas.

The street level navigation allows a user to drive or otherwise move (e.g., walk) along the ground in the 3-D environment. FIG. 3 is an illustration of three different viewpoints of the same 3-D environment displayed from a street level perspective as a user navigates down a road according to an embodiment of the present invention. The first viewpoint 300 illustrates a view down a street 305 in a 3-D representation of an urbanized area such as a small town. The first viewpoint presents a number of buildings 310a, 315a, 320a and a park 325a along the street 305a. The second viewpoint 330 illustrates a view from a point further down the street 305b than the perspective illustrated in the first viewpoint 300. The buildings that previously were distant 315b, 320b and the park 325b are now closer and shown in greater detail while building 310a has dropped out of the view. The third viewpoint 335 illustrates a view from a point virtually at the end of the street 305c as displayed in the first viewpoint 300 and the second viewpoint 330. A portion of the park 325c is still visible in the third viewpoint along with the third building 320c. FIG. 3 illustrates how the user viewpoint or orientation (i.e., the camera angle and perspective) changes as a user navigates through a 3-D environment in street level navigation mode according to one embodiment of the present invention.

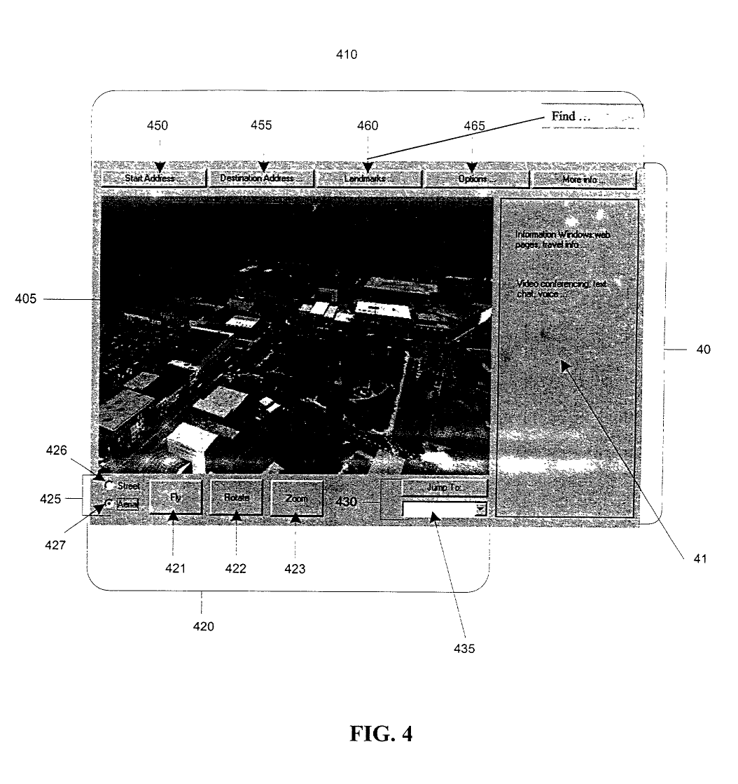

The 3-D virtual environment may also be displayed using a different perspective such as from an aerial navigation mode. FIG. 4 is an illustration of an application graphical user interface (“GUI”) in aerial navigation mode according to one embodiment of the present invention. The example embodiment of the application GUI is similar to that shown in FIG. 2. The application GUI window 400 includes a 3-D virtual environment display 405, a tool bar 410, an information window 415, and navigation commands 420. Unlike the application GUI for a street level navigation mode, the selection of an aerial perspective 427 for the 3-D virtual environment results in a different view of the environment and different navigation commands in the application GUI. For example, the street level navigation commands drive 221 and tilt 222 no longer appear. Instead these navigation commands may be replaced with perspective-sensitive commands such as fly 421, rotate 422, and zoom 423. The fly command 421 may allow a user to move in any direction at a current altitude. The fly command 421 may also allow a user to control the speed at which the user is flying in the 3-D environment. The rotate command 422 may allow a user to rotate the viewpoint around a focal point on the ground. For example, the user may click on the rotate command 422 then click on a point in the 3-D virtual environment 405 causing the viewpoint to rotate around the point in the 3-D environment. The zoom command 423 may allow the user to zoom in directly ahead thus lowering the elevation of the user perspective or zoom out thus increasing the elevation of the user perspective for the aerial view.

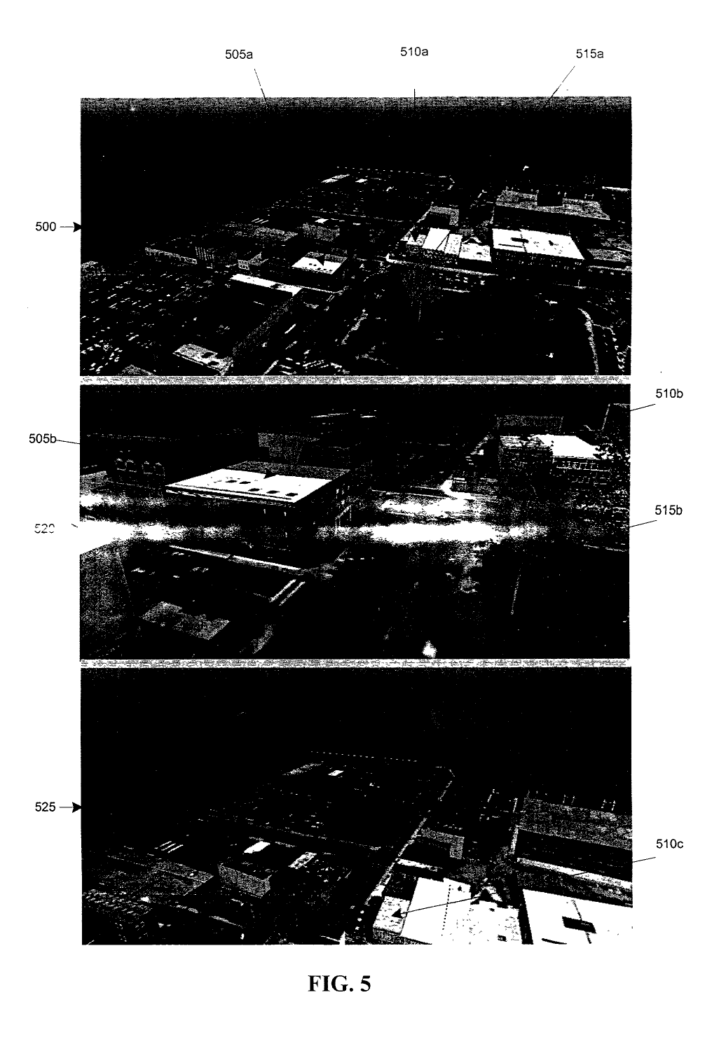

The aerial navigation mode allows a user to fly around the 3-D virtual environment. FIG. 5 is an illustration of three different viewpoints of the same 3-D environment displayed from an aerial perspective as a user navigates and changes elevation within a small town according to an embodiment of the present invention. The first viewpoint 500 shows a portion of a small town. Several buildings 505a, 510a are visible along with a park 515a. The second viewpoint 525 illustrates a user using the zoom in command to decrease the elevation of the aerial perspective and to more closely view the ground environment. The same buildings 505b, 510b and park 515b are still visible but much closer to the user. The user may also zoom out as is illustrated in the third viewpoint 525. The aerial view in the third viewpoint 525 is at the same elevation as the aerial view in the first viewpoint 500. In the third viewpoint 525, only one of the buildings 510c is visible with the other building and park omitted from the viewpoint.

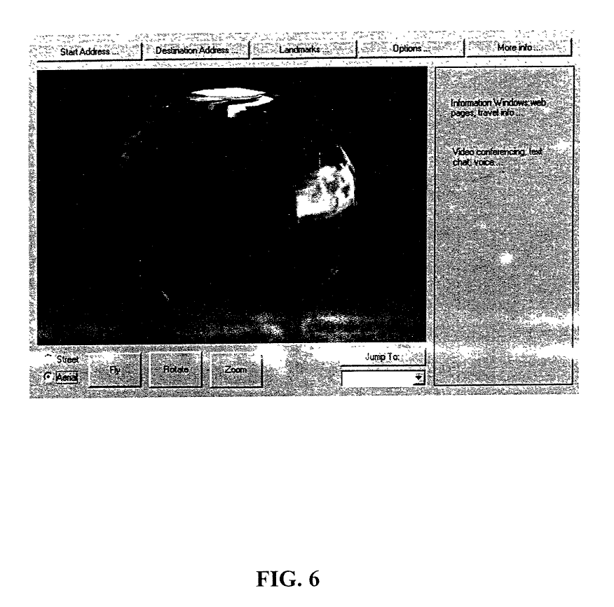

The ability to zoom out and in 423 may be taken to an extreme degree according to one embodiment of the present invention. The user may zoom in to the point where the 3-D virtual environment display has shifted to a street level perspective. The user may zoom out to point where 3-D virtual environment encompasses the entire planet. FIG. 6 is an illustration of a 3-D virtual environment that has been zoomed out to the extreme where the planet Earth is being displayed according to one embodiment of the present invention. In one embodiment, the planet view shown in FIG. 6 may be the default view presented to a user when the user first enters the 3-D virtual environment. The user may then navigate down this top-level view by zooming in or by using the find feature of the present invention. In alternative embodiments, the initial default presentation of the 3-D environment may be the last environment displayed for the user or may be some other generic starting location.

Virtual Trips

As previously discussed, the user may take a virtual trip in the 3-D environment. The user does so by selecting the start address and destination address. The start address may be selected by clicking on the start address button 250, 450 in the tool bar 210, 410 of the application GUI. The destination address may also be selected by clicking on the destination address button 255, 455 in the tool bar 210, 410 of the application GUI. FIG. 7 is an illustration of the start address and destination address pop-up windows according to one embodiment of the present invention. When the user clicks on either the start address or destination address buttons, the appropriate pop-up window will appear allowing the user to specify the appropriate address.

The start address pop-up window 700 allows the user to specify the start address in a number of ways according to one embodiment of the present invention. A user may enter the actual street address 705, a landmark 710, city or town 715, and/or country 720. The city/town 715 and country 720 fields serve to narrow the search for street address 705 and landmark 710 and may not be sufficient in and of themselves to serve as a start address for a virtual trip. City/town 715 and country 720 values may be directly entered or selected from a pull-down menu according to the embodiment of the present invention illustrated in FIG. 7. The landmark field 710 may allow a user to directly enter a landmark or use nested pull-down menus to find a landmark. Landmarks may be organized by category in an initial pull-down menu 730 and then listed by subcategory in a second-level pull-down menu. Landmark categories may include retail landmarks 731, ATMs 732, Billboards 733, gas stations 734, restaurants 735, historic sites 736, lodgings 737, and churches/temples 738 to name a few potential categories. Some landmark categories such as restaurants 735 may further be organized by, for example, type of cuisine resulting in several possible pull-down menu levels. Either a landmark or street address may be entered but both may not be required to specify a start address for a virtual trip.

The destination address pop-up window 750 mimics the start address pop-up window 700 except that the information is used to identify the terminus of the virtual trip. The destination address pop-up window also has city/town 765 and country 770 fields to narrow the search for landmark and street address. The landmark field 760 may allow the direct entry of a landmark and/or selection of a landmark through one or multiple, nested pull-down menus. The landmark categories may and generally should be similar to the landmark categories for the start address. As with start address, either a landmark 760 or street address 755 may be entered but both may not be required to specify a destination address for a virtual trip.

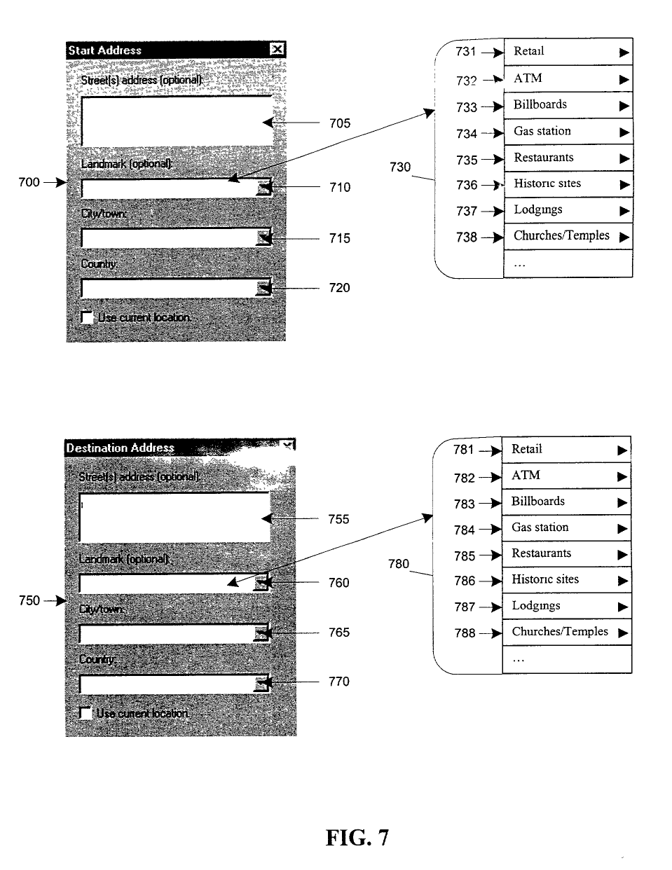

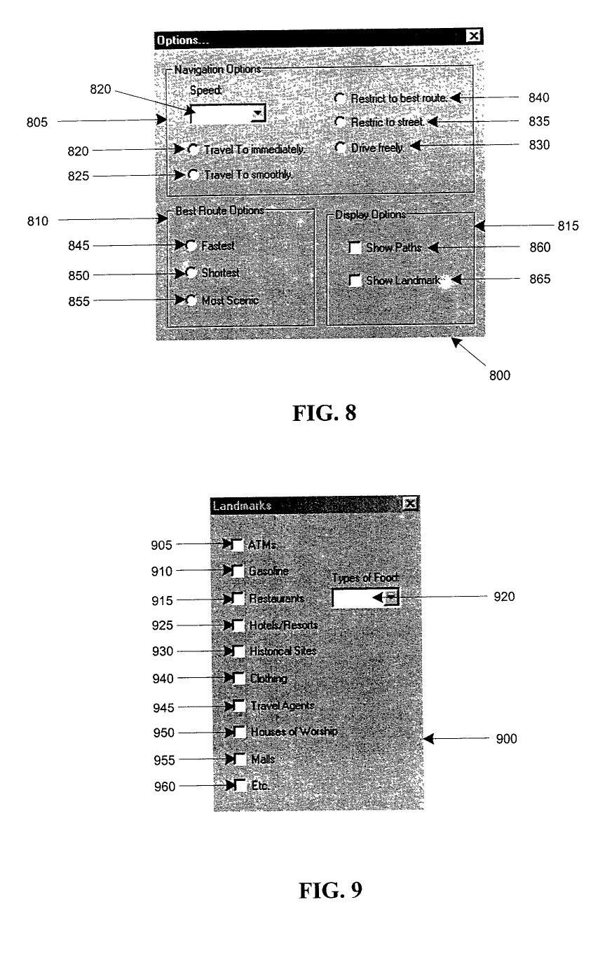

The options button 265, 465 on the tool bar 210, 410 of the application GUI may allow a user to set options effecting how a user moves through the 3-D virtual environment according to one embodiment of the present invention. FIG. 8 is an illustration of the options pop-up window according to one embodiment of the present invention. The options pop-up window 800 may appear when a user clicks on the options button 265, 465 of the application GUI. This pop-up window 800 may allow a user to specify navigation options 805, best route options 810, and display options 815 among other possible choices. Navigation options 805 may include options where a user may specify the speed of travel 820 by either directly entering a value or choosing from a pull-down list of pre-selected values. A user may also decide to jump from the start address to the end address without traveling between the points in the virtual environment. The user may select this option by choosing the “travel to immediately” choice 822 in the first toggle field of the navigation options rather than the “travel to smoothly” choice 825, which results in a virtual trip. In a second toggle field, the user may allow free movement on ground or in the air by selecting the “drive freely” option 830 (or “fly freely” option when in an aerial navigation mode). The user may restrict travel to the roads or to the best route by selecting either the “restrict to street” 835 or “restrict to best route” 840 options, respectively, in the second toggle field of the navigation options 805.

The options pop-up window 800 may also contain a user preference selection for how a best route will be calculated according to one embodiment of the present invention. The example embodiment provides the user with three best route calculation options 810: fastest route 845, shortest route 850, and most scenic route 855. Display options 815 may also be provided to the user. The display options 815 may be used to show or highlight areas of greater interest to a user. For example, a user may choose to mark the best route by selecting the “show path” option 860. A route may be marked with smoke, colored fog, lighting, or any other 3-D or 2-D marker or effect. The “show landmarks” option 865 may also be selected resulting in designated landmarks being displayed with an identifier such as a flag. Displaying landmarks is discussed in greater detail below.

Landmark Identification

The landmarks button 260, 460 on the tool bar 210, 410 of the application GUI may be used to select which landmarks will be identified when the user decides to display landmarks 865 in the options pop-up window 800. According to one embodiment of the present invention, landmarks may be identified with flags but in other embodiments alternative identification means may be used. FIG. 9 is an illustration of the landmark selection pop-up window according to one embodiment of the present invention. The landmark selection pop-up window 900 may contain a list of possible landmarks that the user may select for later identification. For example, ATMs 905, gas stations 910, restaurants 915, hotels/resorts 925, historical sites 930, clothing stores 940, travel agencies 945, houses of worship 950, and malls 955 are all examples of possible landmarks that are included in the landmark selection pop-up window 900 according to one embodiment of the present invention. Landmark categories may further be subdivided into subcategories and sub-subcategories. For example, the restaurants landmark category 915 on the landmark selection pop-up window 900 shown in FIG. 9 is further defined by subcategories 920 based on cuisine. These subcategories are shown in FIG. 9 by a pull-down menu 920 next to the restaurant category option 915.

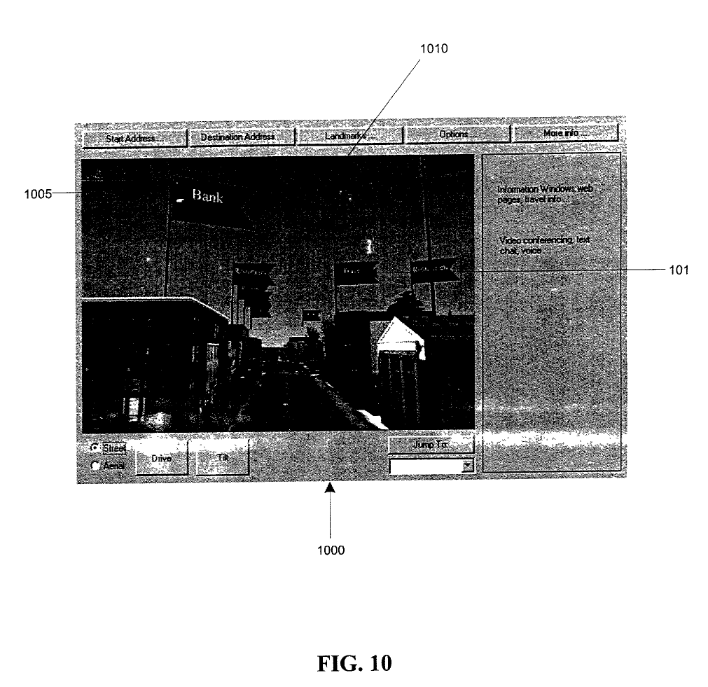

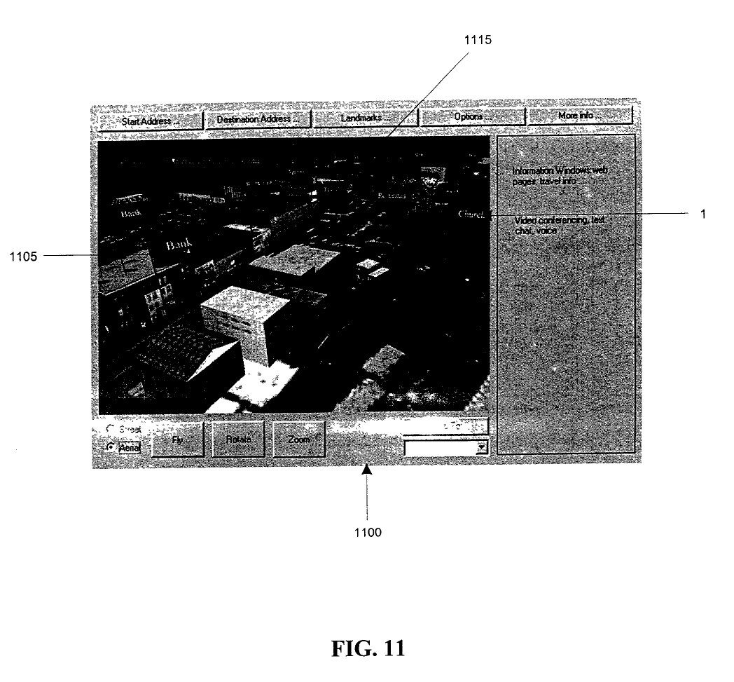

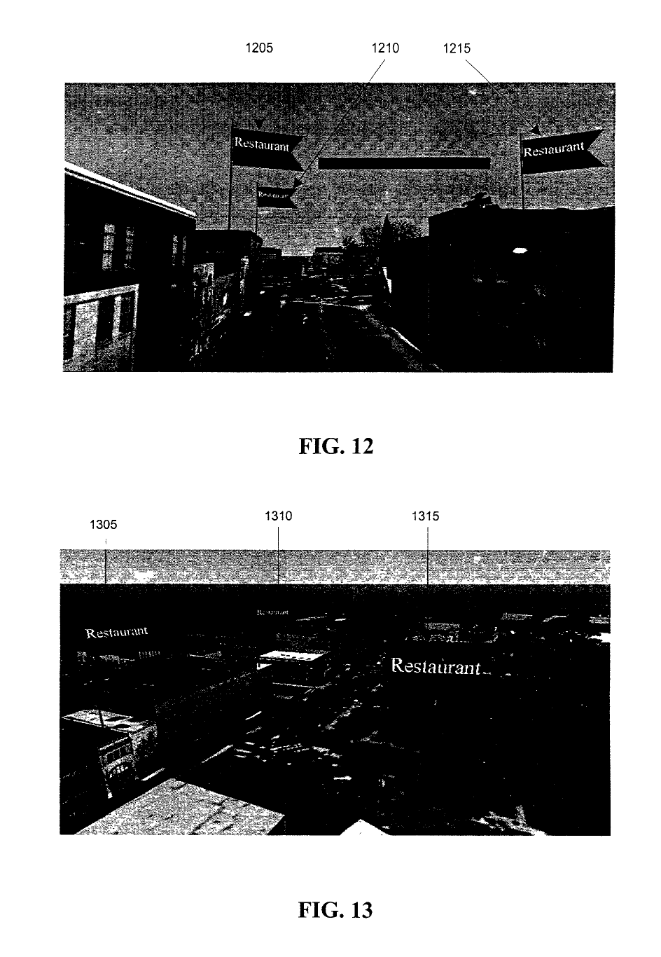

When a user opts to show landmarks 865 in the option pop-up menu 800, the landmarks selected in the landmark selection pop-up menu 900 are labeled or otherwise marked in the 3-D virtual environment according to one embodiment of the present invention. As previously stated, the example embodiment uses flags to mark these landmarks however other marking means may be used in other embodiments of the present invention. FIG. 10 is an illustration of the application GUI displaying a street level view of the 3-D virtual environment where all the landmark categories have been selected and are being shown according to one embodiment of the present invention. The 3-D virtual environment 1000 displays flags identifying each landmark. The closest landmark is a bank 1005 but a restaurant 1110 and a travel agency 1115 among other landmarks are clearly visible to the user. FIG. 11 is an illustration of the application GUI displaying an aerial view of the 3-D virtual environment where all the landmark categories have been selected and are being shown according to one embodiment of the present invention. In this illustration, a bank 1105, a church 1110, and a travel agency 1115 are three examples of landmark identification that are being displayed to the user in the 3-D virtual environment. FIG. 12 is an illustration of the application GUI displaying a street level view of the 3-D virtual environment where only restaurant landmarks have been selected and are being shown according to one embodiment of the present invention. The viewpoint in FIG. 12 is similar to the viewpoint in FIG. 10 except that only three restaurant landmarks 1205, 1210, and 1215 that were also shown in FIG. 10 are identified. FIG. 13 is an illustration of the application GUI displaying an aerial view of the 3-D virtual environment where only restaurant landmarks have been selected and are being shown according to one embodiment of the present invention. The aerial view shown in FIG. 13 shows a 3-D virtual environment where only a limited number of landmarks (i.e., three restaurants 1305, 1310, 1315) are identified and labeled versus the widespread identification of landmarks shown in FIG. 11.

Virtual Directory

The present invention may also be used to provide a virtual directory service according to one embodiment. A virtual directory service may allow a user to find an information item within the photorealistic, 3-D model by narrowing the area within the model where the information may be located and by using visual association to find the information. An information item may be any location, area, intersection, address, structure, and/or landmark in the photorealistic, 3-D model. For example, a user searching for a restaurant may narrow the search area to a particular part of city where the user knows the restaurant to be. The user may then “jump to” that part of the city using the navigation controls and then visually navigate to the restaurant based on the user's memory and visual (e.g., terrain) association between the photorealistic, 3-D model and the actual world depicted. In another example, a user may find a book in a library by navigating to a particular section then visually searching to find the aisle and then the shelf where the user knows the book to be. The user may, for example, then browse the titles on the shelf to find the desired book. As may be obvious, this particular service is most beneficial when a user does not recall the name of the information item but knows the approximate location. Even where the an approximate location is not known, the user may visually browse within the photorealistic, 3-D model to find the information item. This service is also most beneficial when the photorealistic, 3-D model is a sufficiently accurate depiction of an actual place and/or actual entity to allow a user to use their knowledge or memory to search for the desired information item by visual association (e.g., terrain association) between the model and the actual location and/or entity.

Commercial Services

One aspect of the present invention may include the provision of commercial services. Commercial services may include the commercial use of the present invention. For example, the present invention may incorporate advertising as is discussed below. Other commercial uses include the sale and/or rental of virtual property within the photorealistic, 3-D model. For example, a store, building, or billboard in a model may be sold and/or rented to a customer. Another commercial use may be the sale and/or rental of real property by allowing the photorealistic, 3-D model to be used as a marketing tool (e.g., by allowing a user to thoroughly view a property) and/or used as a vehicle (e.g., through user interaction in the photorealistic, 3-D model) for the sale of real property. This commercial use may also allow for the joint sale and/or rental of real and virtual property whereby the user purchasing or leasing a real property may then own and/or lease or be allowed to use the associated property in the photorealistic, 3-D model. Other commercial uses may include the use of the photorealistic, 3-D model for the sale of merchandise as previously discussed. The sale of merchandise may occur through user interaction with the model such as the user visiting a virtual store in the model and purchasing goods or services made available there. The exemplary embodiments are just some of the many commercial services of the present invention.

Another commercial use in one embodiment of the present invention may be the ability to allow a user to move, add, modify, delete, or import objects (e.g., a building or a sign) in a 3-D model. The changes permitted according to this embodiment may allow a user to explore (from all or a wide variety of angles) the potential impact of changes to an actual location and/or entity prior to making the changes in the real world. For example, developers and town planners may see what a new or refurbished building may look like in its appropriate context (i.e., in situ). In another example, a building and/or store owner may see what potential changes will look like, such as the addition of a sign or changes to an interior, prior to making them.

Multi-User Interface

Another aspect of the present invention may include a multi-user environment for the photorealistic, 3-D model. A multi-user environment may include the simultaneous use of a model by multiple users who may be able to interact in real-time with one and other within the photorealistic, 3-D model (possibly through the use of avatars). A multi-user environment and multi-user interaction may be used to facilitate commerce such as the example with a store clerk interacting with a user in the model. Another example of multi-user interaction may include educational services where teachers and students may interact in the photorealistic, 3-D model. Numerous other uses in the commercial, entertainment, and educational fields among others exists for exploiting a multi-user environment and/or multi-user interaction in a photorealistic, 3-D model depicting at least one of an actual place and/or actual entity.

Advertising within the 3-D Environment

One aspect of the present invention may include advertising presented within the 3-D environment. An advertising item used in the 3-D environment may include all or part of an advertisement and may take the form of, for example, a moving or stationary 3-D object, an animation of some sort, or even an advertising element linked to a 3-D environment object such as a sign on a car or a bull horn on a car playing an advertisement. This type of advertising may substantially differ from conventional advertising that may be included in the navigation controls or in separate banners typically associated with possible host applications such as Web browsers. One difference may include the seamless integration or blending of an advertising item (e.g., an advertisement) with the 3-D environment presenting a more integrated approach where the advertising item appears as a natural part of the 3-D environment. For example, if the 3-D environment represents Times Square in New York, advertising items may be included on the electronic billboards that are part of Time Square thereby making the advertisements appear as a natural part of the photorealistic 3-D environment depicting Times Square. In another example, a 3-D environment representing a small town may include a bus stop that normally contains one or more billboard advertisements. These billboard advertisement spaces may be used to include advertising items within the 3-D environment that is at the same time providing added realism to 3-D model of the town. Advertising items may also be inserted into the 3-D environment in a seamless manner even where the inserted advertising item does not depict or is not located at an actual advertising space. For example, billboards may be added to the 3-D environment in locations where a billboard does not exist at the actual location. Even though this artificial addition of a billboard does not correspond to the reality being represented by the model, the placement, sizing and style of the billboard may be done in such a manner as to make it look like an actual billboard would if one actually did exist at that location. One example of this may include adding additional billboards along a road or on a building. Whether as part of the photo-realistic representation of an actual location or inserted into it, advertising may be included in various forms throughout the 3-D environment.

Advertisements in the photorealistic 3-D environment may take a variety of forms according to various embodiments of the present invention. For example, advertising may be implemented by the inclusion in the 3-D environment of, inter alia, billboards, placards, store signs, logos, sandwich board advertisements, or even animated sidewalk vendors hawking particular goods. As previously discussed, billboards may be used to represent actual billboards found in the location being modeled. For example, the electronic billboards found in Times Square may be recreated in the 3-D environment. Billboards may also be inserted into the 3-D environment. Placards and other signs may be posted on buildings and elsewhere to either simulate actual signs or to incorporate additional advertising items. Distinctive store signs may also be included in the 3-D environment. For example, a McDonald's golden arches sign and distinctive restaurant markings may be incorporated in the 3-D environment.

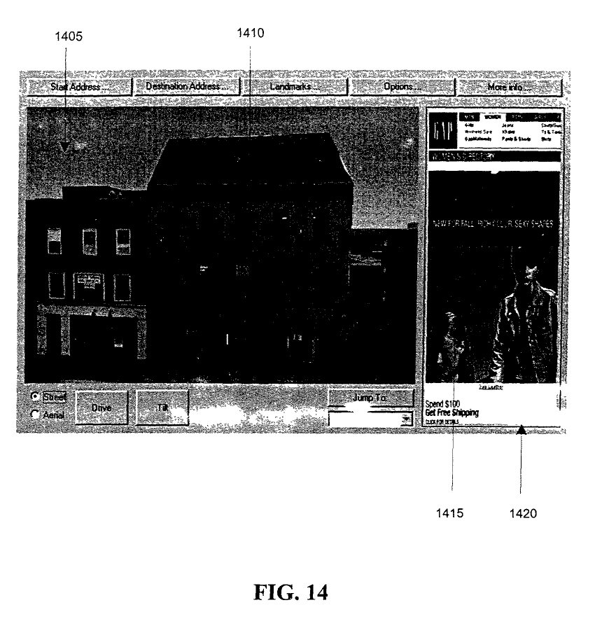

In addition to the diverse methods by which advertising may be included in the 3-D environment, the type of advertising item may also be diverse. For example, the advertising item (i.e., advertising content) may include text, images, animation, video, and sound. The advertisements themselves may also be capable of further manipulation allowing the advertising item to be, for example, rotated and/or zoomed in or out. Additionally, the advertising item may incorporate a hyperlink next to the advertising item or linked directly to the advertising item so that when a user clicks on the hyperlink or on the advertising item linked to the hyperlink, a Web page for that advertiser may be displayed. The Web page may be displayed in a new window or may be incorporated as part of the information window 215 of the application GUI. FIG. 14 is an illustration of an advertiser's Web page displayed in the information window of the application GUI as a result of a user clicking on a hyperlink associated with the advertiser's store located in the 3-D virtual environment according to one embodiment of the present invention. The application GUI 1400 displays a Gap® store 1410 in the 3-D virtual environment 1405. A hyperlink is associated with the store 1410 so that when a user clicks on the store, a Gap® Web page 1415 is displayed in the information window 1420 of the application GUI 1400.

Revenue Generation

Revenue generation may also be an additional aspect of one or more embodiments of the present invention. For example, the present invention operator (e.g., the operator of the virtual environment Web server network node) may charge a fee for the inclusion of an advertising item in the photorealistic, 3-D environment. The charged fee may include a limitation on the use of the advertising item or may cover the permanent inclusion of the advertising item in the 3-D environment. The limitation may, for example, be a time limitation (in other words a duration limit) whereby the advertising item is made available to all users of the 3-D environment during a particular period of time. The limitation may also, for example, be a user limitation whereby the advertising item is only made available to a certain number of users or for a certain number of visits. The fee for an advertising item may include multiple limitations such as, for example, a duration and a user limit whereby the advertising item is only made available for a certain period of time in which it will only be made available up to a maximum number of users. Charging for the inclusion of an advertising may be only one of a number of possible revenue generation methods that may be associated with various embodiments of the present invention.

In other embodiments of the present invention, the present invention operator may charge for additional services and/or features that may be provided. For example, the present invention operator may charge a fee to upgrade a particular portion of the photorealistic, 3-D environment. This upgrade may include enhanced resolution and/or detail or may include the provision of additional features and/or services such as, for example, providing lights which may turn on and off or providing an interior environment. These services and/or features may be desirable in a number of contexts including, inter alia, a store in the 3-D environment. Other services and/or features that may provided for a fee may include interaction with users in the 3-D environment including the use of chat, voice, video, and/or avatars. These and other service and/or features may be used for the direct selling of goods and/or services through the 3-D environment. The embodiments discussed above are merely examples of the numerous revenue generation possibilities of the present invention. The present invention operator may charge for any feature and/or service provided by or through the 3-D environment.

What is claimed is:

1. A method for providing a virtual interaction with a real-life entity, comprising the steps of:
generating a photorealistic, 3-D model of the entity, wherein the photorealistic, 3-D model corresponds to a physical structure of the entity and includes information for rendering a graphical representation of the entity;
receiving at least one navigation parameter, wherein the navigation parameter corresponds to an orientation relative to the entity;
receiving at least one interaction parameter, wherein the interaction parameter corresponds to an action relative to the entity; and
displaying a photorealistic, 3-D image of the entity as a function of the navigation parameter, the interaction parameter, and the information for rendering a graphical representation of the entity.

2. The method according to claim 1, wherein the interaction parameter corresponds to a trip planning action.

3. The method according to claim 1, wherein the interaction parameter corresponds to a route marking action.

4. The method according to claim 1, wherein the interaction parameter relates to an interaction between a first party and a second party.

5. The method according to claim 4, wherein at least one of the first party and the second party is represented by an avatar in the photorealistic, 3-D image.

6. A method for trip planning using an electronic medium, comprising the steps of:
generating a photorealistic, 3-D model of a real-life entity, wherein the photorealistic, 3-D model corresponds to a physical structure of the entity and includes information for rendering a graphical representation of the entity;
receiving a first route end point, wherein the first route end point corresponds to a first location relative to the entity;
receiving a second route end point, wherein the second route end point corresponds to a second location relative to the entity;
determining a route between the first route end point and the second route end point;
determining an orientation relative to the entity, wherein the orientation corresponds to a movement along the route; and
displaying a photorealistic, 3-D image of the entity as a function of the orientation and the information for rendering a graphical representation of the entity.

7. The method according to claim 6, wherein the first route end point corresponds to at least one of an area, an intersection, an address, a structure, a store, a residence, and a landmark relative to the entity.

8. The method according to claim 6, wherein the second route end point corresponds to at least one of an area, an intersection, an address, a structure, a store, a residence, and a landmark relative to the entity.

9. A method for route marking on an electronic medium, comprising the steps of:
generating a photorealistic, 3-D model of a real-life entity, wherein the photorealistic, 3-D model corresponds to a physical structure of the entity and includes information for rendering a graphical representation of the entity;
receiving a first route end point, wherein the first route end point corresponds to a first location relative to the entity;
receiving a second route end point, wherein the second route end point corresponds to a second location relative to the entity;
determining a route between the first route end point and the second route end point;
determining route marking information relative to the entity, wherein the route marking information includes information for rendering at least one of a 2-D effect and a 3-D effect; and
displaying a photorealistic, 3-D image of the entity as a function of the route marking information and the information for rendering a graphical representation of the entity.

10. The method according to claim 9, wherein the first route end point corresponds to at least one of an area, an intersection, an address, a structure, a store, a residence, and a landmark relative to the entity.

11. The method according to claim 9, wherein the second route end point corresponds to at least one of an area, an intersection, an address, a structure, a store, a residence, and a landmark relative to the entity.

12. A method for advertising on an electronic medium, comprising the steps of:
generating a photorealistic, 3-D model of a real-life entity, wherein the photorealistic, 3-D model corresponds to a physical structure of the entity and includes information for rendering a graphical representation of the entity;
receiving at least one advertising information item, wherein each advertising information item includes at least one of content information and link information for displaying a corresponding advertisement relative to the photorealistic, 3-D model; and
displaying a photorealistic, 3-D image of the entity and at least one advertisement, wherein the 3-D image is displayed as a function of the information for rendering a graphical representation of the entity and wherein each advertisement is rendered relative to the 3-D image as a function of the link information.

13. The method according to claim 12, wherein the content information includes at least one of a video content item, an audio content item, a logo and a trade dress item.

14. The method according to claim 13, wherein the trade dress item includes at least one of a structure and a color scheme.

15. A system for advertising on an electronic medium, comprising:
a storage device;
a processor, wherein the processor is adapted to:
(i) store, on the storage device, a photorealistic, 3-D model of a real-life entity, wherein the photorealistic, 3-D model corresponds to a physical structure of the entity and includes information for rendering a graphical representation of the entity;
(ii) receive at least one advertising information item, wherein each advertising information item includes at least one of content information and link information for displaying a corresponding advertisement relative to the photorealistic, 3-D model; and
(iii) display a photorealistic, 3-D image of the entity and at least one advertisement, wherein the 3-D image is displayed as a function of the information for rendering a graphical representation of the entity and wherein each advertisement is rendered relative to the 3-D image as a function of the link information.

16. The system according to claim 15, wherein the content information includes at least one of a video content item, an audio content item, a logo and a trade dress item.

17. The system according to claim 16, wherein the trade dress item includes at least one of a structure and a color scheme.

18. A system for advertising on an electronic medium, comprising:
a storage device;
a program memory;
a first processor connected to an information network, wherein the first processor is adapted to:
(i) store, on the storage device, a photorealistic, 3-D model of a real-life entity, wherein the photorealistic, 3-D model corresponds to a physical structure of the entity and includes information for rendering a graphical representation of the entity;
(ii) receive at least one advertising information item, wherein each advertising information item includes at least one of content information and link information for displaying a corresponding advertisement relative to the photorealistic, 3-D model;
(iii) transmit, over the information network, at least one of the photorealistic, 3-D model, the information for rendering the graphical representation of the entity, the advertisement, the advertising information item, the content information, and the link information; and
a second processor connected to the information network, wherein the second processor is adapted to:
(i) receive, over the information network, into the program memory at least one of the photorealistic, 3-D model, the information for rendering the graphical representation of the entity, the advertisement, the advertising information item, the content information, and the link information;
(ii) display, from the program memory, a photorealistic, 3-D image of the entity and at least one advertisement, wherein the 3-D image is displayed as a function of the information for rendering a graphical representation of the entity and wherein each advertisement is rendered relative to the 3-D image as a function of the link information.

19. The system according to claim 18, wherein the information network is at least one of an Internet, a local area network, a wireless network, and an Intranet.

20. The system according to claim 18, wherein the content information includes at least one of a video content item, an audio content item, a logo and a trade dress item.

21. The system according to claim 20, wherein the trade dress item includes at least one of a structure and a color scheme.

22. A medium storing instructions adapted to be executed by a processor to perform the steps of:
generating a photorealistic, 3-D model of a real-life entity, wherein the photorealistic, 3-D model corresponds to a physical structure of the entity and includes information for rendering a graphical representation of the entity;
receiving at least one advertising information item, wherein each advertising information item includes at least one of content information and link information for displaying a corresponding advertisement relative to the photorealistic, 3-D model; and
displaying a photorealistic, 3-D image of the entity and at least one advertisement, wherein the 3-D image is displayed as a function of the information for rendering a graphical representation of the entity and wherein each advertisement is rendered relative to the 3-D image as a function of the link information.

23. A method for generating advertising revenue on an electronic medium, comprising the steps of:
generating a photorealistic, 3-D model of a real-life entity, wherein the photorealistic, 3-D model corresponds to a physical structure of the entity and includes information for rendering a graphical representation of the entity;
receiving at least one advertising information item, wherein each advertising information item includes at least one of content information and link information for displaying a corresponding advertisement relative to the photorealistic, 3-D model;
displaying a photorealistic, 3-D image of the entity and at least one advertisement, wherein the 3-D image is displayed as a function of the information for rendering a graphical representation of the entity and wherein each advertisement is rendered relative to the 3-D image as a function of the link information; and
receiving a revenue stream for each advertisement.

24. The method according to claim 23, wherein the content information includes at least one of a video content item, an audio content item, a logo and a trade dress item.

25. The method according to claim 24, wherein the trade dress item includes at least one of a structure and a color scheme.
